(19) United States
(12) Patent Application Publication
(10) Pub. No.: US 2007/0010259 A1
(43) Pub. Date: Jan. 11, 2007

(54) Method and apparatus for providing a wireless transmit/receive unit user with signal quality guidance

(75) Inventor: John Erich Hoffmann, Indialantic, FL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/210,089

(22) Filed: Aug. 23, 2005

Related U.S. Application Data
(60) Provisional application No. 60/698,212, filed on Jul. 11, 2005.

(51) Int. Cl. H04B 17/00

(52) U.S. Cl. 455/456.1

(57) ABSTRACT

The current location and bearing of a wireless transmit/receive unit (WTRU) are determined. Next, signal quality measurements of a pre-determined geographic region are taken. This geographic region includes the current location of the WTRU. From these quality measurements, a signal quality profile is generated. The signal quality profile and a directional guidance indicator are then displayed to the user of the WTRU. The display indicates areas of preferred signal quality relative to the current location of the WTRU.

### CROSS REFERENCE TO RELATED APPLICATIONS

This application claims the benefit of U.S. Provisional Application No. 60/698,212 filed on Jul. 11, 2005, which is incorporated by reference as if fully set forth herein.

### FIELD OF INVENTION

The present invention is related to wireless communication systems. More particularly, the present invention is related to a method and apparatus for providing wireless transmit/receive unit (WTRU) users with signal strength guidance.

### BACKGROUND

As the use of wireless mobile communication devices for the transmission and reception of data increases, the need for finding acceptable levels of signal quality increases. In communication systems in which communicating entities are fixed, it is possible to account for user locations and accordingly, engineer data structures that consistently deliver acceptable or desired levels of signal quality to the fixed communication entities. By contrast, in communication systems comprising wireless/mobile devices, it is nearly impossible to account for user locations, making it very difficult to consistently provide a desired signal quality to these mobile devices. In such systems, the amount of signal quality available to the mobile devices often varies across the geographical landscape of each particular system. This affects the ability of a user to maintain or initiate a wireless service with a desired signal quality as he moves from one location to another.

In any given wireless communication system, movement of mobile devices affects the level of signal quality experienced by these devices. The extent to which signal quality is affected depends on several factors, including but not limited to: the distance between the transmitting unit and the receiving unit, the signal strength of the transmitting unit, environmental signal degraders between communication units such as buildings, other communication networks, and nature (e.g. trees, hills), etc. Even if transmission units are able to transmit signals at a consistent signal quality level, factors such as distance to receiving units and geographical landscape of the system are often determinative of the signal quality experienced by receiving units.

One way manufacturers have attempted to improve signal quality in wireless systems is to equip their mobile devices with a quality indicator display. A processing unit, often contained within a mobile device, detects the relevant wireless signal, determines the strength of that signal, and displays the determination for the user. The term “relevant wireless signal” is used because a mobile device may operate in an environment in which multiple communication systems exist. Most wireless communication units are currently capable of this technology.

The display type most often used in the current art includes signal bars 11, as illustrated the mobile device 10 in FIG. 1. The display 12 primarily consists of a series of bars 11 arranged in parallel with a subsequent bar size being incrementally larger than the preceding bar size. The signal strength is presented to the user in the form of the association of the measured signal strength with a predetermined number of bars 11. The user can ascertain signal strength by the number of bars presented on the display. Another display type used is a sliding scale display (not shown) in which signal quality is presented to the user by a changing bar size, which is a function of a maximum possible 100% signal quality.

While adequate for displaying a current relative signal strength, signal bars are limited in their utility. A user, either when initiating a communication link or while moving from one location to another during a communication, is provided no information about how the signal quality of his current location compares to that of surrounding locations. In addition, the user is given no input as to where to move if the signal quality becomes unacceptable or undesirable. As a result, to find an acceptable or desired signal quality, the user may have to attempt to determine on his own, areas of desired signal quality. Accordingly, it is desirable to have a method and apparatus for providing current location and surrounding location signal quality information to assist users in identifying suitable locations for wireless communications.

### SUMMARY

The present invention is related to a method and apparatus for improving signal quality in a wireless transmit/receive unit (WTRU) by guiding users of the WTRU towards areas of preferred signal quality. First, the current location and bearing of the WTRU are determined. Next, signal quality measurements of a pre-determined geographic region are taken. This geographic region includes the current location of the WTRU. From these quality measurements, a signal quality profile is generated. The signal quality profile and a directional guidance indicator are then displayed to the user of the WTRU. The display indicates areas of preferred signal quality relative to the current location of the WTRU.

### BRIEF DESCRIPTION OF THE DRAWINGS

FIG. 1 is a conventional mobile device comprising a signal strength display.

FIG. 2 is a conventional wireless communication system.

FIG. 3 is a block diagram of a wireless transmit/receive unit (WTRU) configured in accordance with the present invention.

FIG. 4 illustrates a WTRU configured to display a signal quality profile with a guidance indicator in accordance with the present invention.

FIG. 5 illustrates an example of an isobar-type display for use in a WTRU configured in accordance with the present invention.

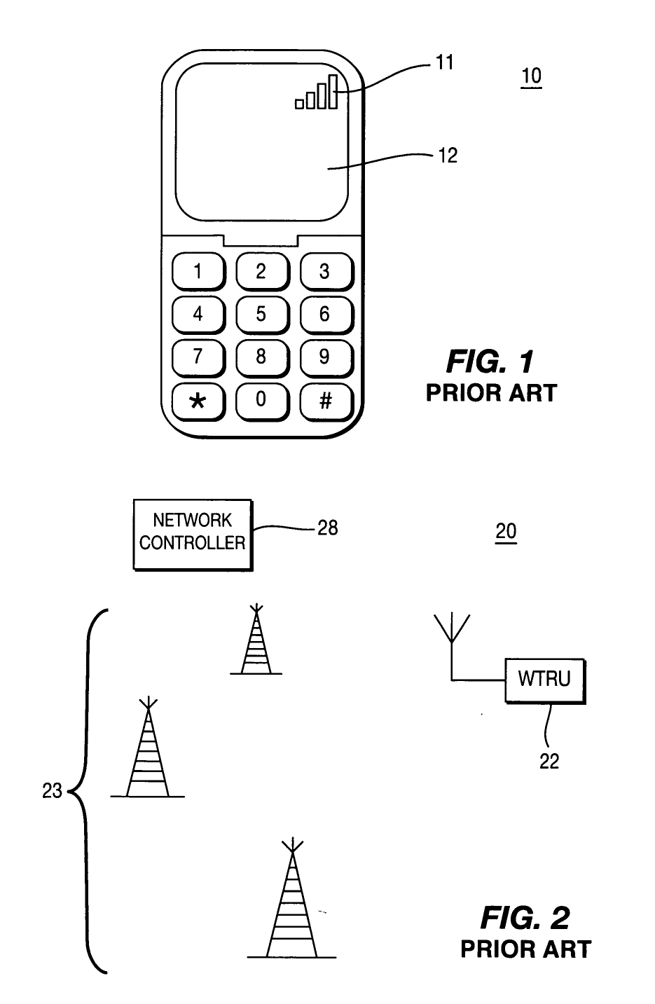

### DETAILED DESCRIPTION OF THE PREFERRED EMBODIMENTS

Herein, the terminology “WTRU” includes but is not limited to a user equipment, a mobile station, a fixed or mobile subscriber unit, a pager, or any other type of device capable of operating in a wireless environment. When referred to herein, the terminology “base station” includes but is not limited to a cellular base station (tower), a cellular amplifier/repeater, a Node-B, a site controller, an access point or any other type of interfacing device in a wireless environment. All references to signal quality are meant to be descriptive of several metrics including, but not limited to, signal strength, signal-to-noise ratio, bit error rate and frame error rate.

In addition, the phrase “signal quality”, as used herein, is not intended to be limiting. To the contrary, signal quality includes signal strength, bit error rate (BER), signal-to-noise ratio (SNR), frame error rate (FER), and/or any other desired signal quality metric.

Referring now to FIG. 2, a diagram of a conventional wireless communication network 20 comprising a network controller 28, a plurality of base stations 23 and at least one WTRU 22 is shown. The network 20 may be any type of wireless communication network and is not required to be of a specific type for purposes of the present invention. As the WTRU 22 moves throughout the network 20, the WTRU 22 experiences different levels of signal quality. The closer the WTRU 22 gets to a base station 23, for instance, the better the signal quality it experiences. As the signal quality improves, the WTRU 22 displays a quality indicator, such as signal strength bars (not shown), to a user. The WTRU 22, however, is incapable of guiding a user towards locations in the network 20 of improved signal reception. As a result, the user is left to determine, perhaps via trial-and-error, locations of improved signal quality within the network 20.

By contrast, a WTRU configured in accordance with the present invention measures a signal quality within a particular region and correlates its current location information with the measured signal quality information. The WTRU then creates a visual signal quality profile, and preferably directional indicators, for presentation to a user. This profile and guidance information enables the user to identify and move towards locations having an improved signal quality.

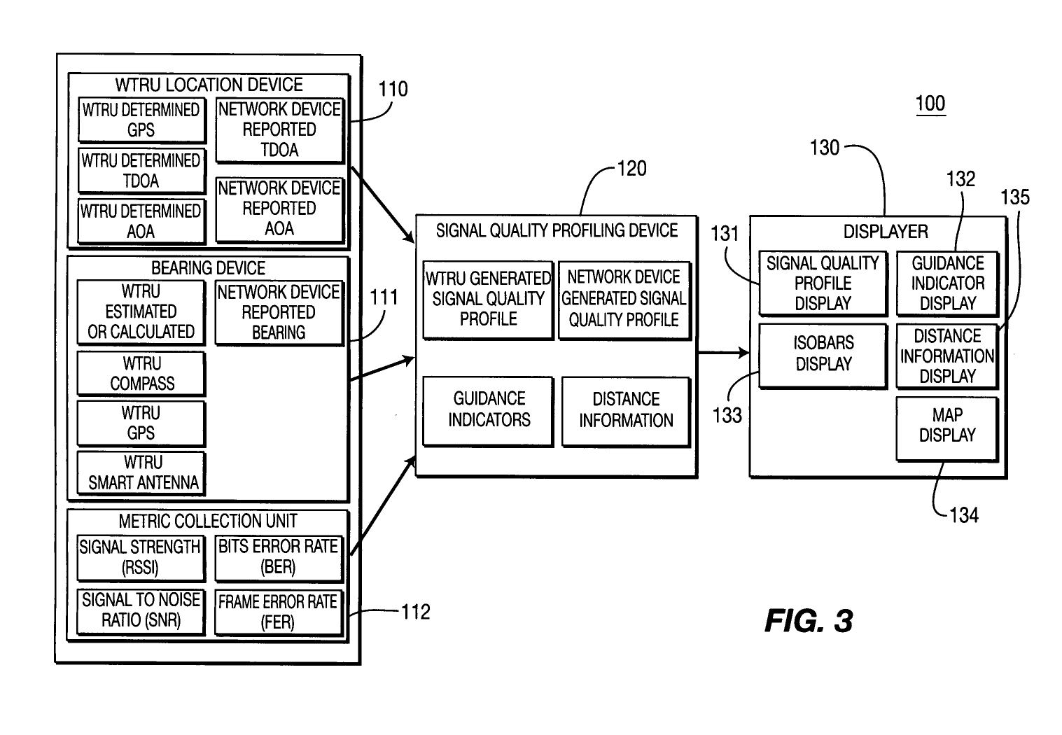

Referring now to FIG. 3, a functional block diagram of a WTRU 100 configured in accordance with the present invention is shown. In order to provide signal quality guidance to a user, the WTRU 100 requires location, bearing and signal quality information. Accordingly, the WTRU 100 comprises a location device 110 for obtaining and/or determining information regarding a location of the WTRU 100, a bearing device 111 for providing bearing or directional orientation information to the WTRU 100, and a metric collection unit 112 for obtaining and providing signal quality information to the WTRU 100. In addition, the WTRU 100 comprises a signal quality profiling device 120 for generating a signal quality profile and directional guidance indicators for guiding a user towards areas of preferred signal quality. A displayer 130 is also included in the WTRU 100 for displaying the signal quality profile and guidance information to the user.

In a preferred embodiment, the location device 110 is configured to determine a current location of the WTRU 100 using, for example, an internal global positioning system (GPS) receiver (not shown). Alternatively, the location device 110 may be configured to utilize time difference of arrival (TDOA) analysis, angle of arrival (AOA) analysis, or any other appropriate internal means for determining a current location of the WTRU 100. The location device 110 may also obtain location information from any external sources, such as an external GPS receiver or a network device. A GPS receiver, for example, can utilize global positioning technology, determine the location of the WTRU 100, and transmit the same to the location device 110. Similarly, an adequately configured base station may employ TDOA analysis, AOA analysis, or any other locating means to determine the location of the WTRU 100, and report the determined location information to the location device 110.

The bearing device 111 is preferably configured to measure, calculate, and/or estimate bearing information, (e.g., north, south, east or west), either independently or in conjunctions with other components internal to the WTRU 100, such as a compass, GPS unit, and/or smart antennae (not shown). Alternatively, the bearing device 111 may obtain bearing information by receiving measurements provided by an external network device, such as by a base station (not shown). For purposes of the present invention, the methods and/or devices utilized for obtaining bearing information are not paramount to the present invention. Accordingly, any appropriate means for determining bearing information of the WTRU 100 may be employed without departing from the scope of the present invention.

The metric collection unit 112 is preferably configured to obtain and evaluate signal quality over a predefined geographic evaluation surface. As indicated above, signal quality may be defined using received signal strength indicators (RSSI), bit error rate (BER), signal-to-noise ratio (SNR), frame error rate (FER), or any other metric deemed appropriate for the particular application. Since it is impractical to attempt to determine a signal quality for every point in an evaluation surface, the metric collection unit 112 preferably measures a select quantity of predefined measuring points and interpolates the values of unmeasured surface points, thereby creating a surface map indicative of the location's signal quality. As the evaluation surface changes, or as new surface points are detected, the metric collection unit 112 updates the map surface by measuring and/or interpolates the signal quality value(s) of the new surface point(s).

It should be noted that the metric collection unit 112 may also obtain relevant signal quality information, including a signal quality surface map, via any appropriate means including via a network device. A base station, for example, may collect signal quality information from WTRUs operating in a desired geographic area, including WTRU 100, compile the information and either generate its own signal quality surface map or provide the information to the WTRU 100 to enable the WTRU 100 to generate the surface map. The map may contain real time data or data that has been averaged over a predetermined period of time.

The WTRU 100 also includes a signal quality profiling device. Once current location information, bearing information and signal quality information are determined, the signal quality profiling device 120 generates a signal quality profile. This profile may be generated from information provided by devices 110, 111, 112 internal to the WTRU 100, or from information provided by an external network device, such as a base station. In addition to generating a signal quality profile, the signal quality profiling device 120 preferably generates directional guidance indicators to enable a user to identify and locate areas of a desired signal quality. The signal quality profile and guidance indicators are then provided to a displayer 130. As further discussed below, the displayer 130 may be configured to display the signal quality profile and/or any other desired information in any manner desired. For example, in a preferred embodiment, the displayer 130 includes a signal quality profile display 131 for displaying quality profiles using, for example, lines and colors. In addition, the displayer 130 may include a guidance indicator display 132 configured to display various user-selected indicators. An isobar-type display 133, a map display 134, and a distance information display 135 are also preferably included in the displayer 130. Depending on the particular implementation, more and/or less features may be added to the displayer 130. It should be understood, however, that any display feature(s) may be added to, or substituted for, those features described herein without departing from the scope of the present invention.

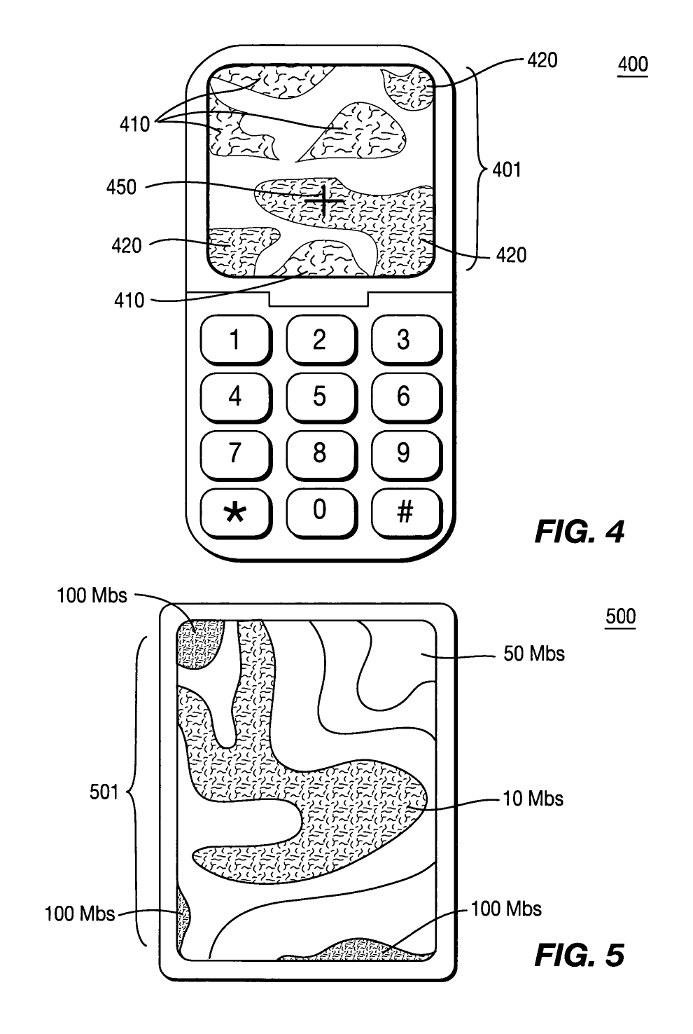

Referring now to FIG. 4, a cellular telephone 400 comprising a displayer 401 configured in accordance with the present invention is shown. This telephone 400 is purely illustrative and not intended to be limiting. Any form of WTRU, as defined above, may utilize and implement the present invention.

Referring back to FIG. 4, the telephone 400 comprises a displayer 401, wherein a signal quality profile in accordance with the present invention is shown. As the Figure indicates, the displayer 401 is using color indicator 410, 420 to display the current signal quality profile. The lighter colored areas 410, for example, may be used to indicate areas of poor signal quality, whereas the darker colored areas 420 may be used to indicate areas of a desired signal quality. Displayed in the center of the displayer 401 is a guidance indicator 450. This guidance indicator 450 is indicative of the relative location of the telephone 400 with respect to the various areas of signal quality 410, 420. As illustrated in FIG. 4, the guidance indicator 450 is indicating that the telephone 400 is presently located in an area of desired signal quality. As a telephone 400 is moved to other geographic locations, the displayer 400 updates the quality regions 410, 420 displayed with respect to the guidance indicator 450. This enables a mobile user communicating via the telephone 400 to avoid areas of poor signal quality and/or to move toward areas of desired signal quality.

The signal profile and guidance indicator described with regard to FIG. 4 are illustrative and should not be considered limiting. To the contrary, any display format and/or guidance indicator may be utilized to assist a user in identifying areas of poor and/or desired signal quality. Referring back to FIG. 3, the displayer 130 may be configured to display a signal quality profile using, for example an isobar display 133. This isobar-type display 133 may be utilized, for example, to indicate anticipated data rates as a function of the WTRU's 100 current location, wherein different colors indicate different data rates. A user may utilize this isobar-type of display 133, for example, to identify locations suitable for transmitting image, multi-media, combined voice-data, or any other type of information requiring higher data rates. Depending on the WTRU's 100 physical layer, grades of service that delineate the isobar lines are preferably also displayed.

Referring now to FIG. 5, a displayer 500 comprising an illustrative isobar display 501 is shown. As indicated by FIG. 5, the isobar display 501 resembles a weather map used to identify variations in pressure levels throughout a particular region or country. With regard to the present invention, lines and/or colors may be used to identify regions of varied signal quality. To illustrate, suppose the isobar display 501 shown in the displayer 500 represents a region of a CDMA communication system, wherein there are three distinct code rates available on the forward link, 10 Mbs, 50 Mbs, and 100 Mbs. Lines and colors separate the three code rate regions, wherein the lightly-shaded regions represent areas of 10 Mbs, the white regions represent areas of 50 Mbs, and wherein the dark colored regions represent areas of 100 Mbs. A user may utilize this isobar display 501 as a guide in order to achieve a “jump”, similar to those found in IEEE 802.11 systems, from a lower data rate to a higher data rate.

In addition to displaying signal quality profiles in terms of quality profiles or isobars, the WTRU 100 may display, for example, a map via a map display feature 134 which incorporates a signal quality profile, colors, lines, isobars, etc., and/or directional indicators, into a map of a region, city, neighborhood, service cell, or any other pre-defined area. In a preferred embodiment, the map display 134 is configured to periodically update the displayed map to correspond with updates in the signal quality profile.

As with previously described display features 131, 132, 133, the guidance indicator display 132 may be configured to display any form of guidance indicator, in conjunction with or independent from the signal quality profile, in any format deemed appropriate by a user. As discussed with regard to FIG. 4, the guidance indicator may be displayed as a simple “+” 450 located in the center of a displayer 401 which shows a relative distance to areas of differing signal quality 410,420. Additionally or alternatively, the guidance indicator display 132 may comprise a directional arrow which moves and points a user towards areas of desired signal quality and/or away from areas of poor signal quality. This directional indicator may also include a compass-type header whereby the user is aware of a particular direction of areas of desired signal quality.

Distance information provides another means of guiding a user towards areas of preferred signal quality. In this regard, the distance information display 135 may be configured to display distance information via text, numbers, symbols, colors, lines, or any in other format desired by a user. The distance information display 135 may be used in conjunction with, for instance, a guidance indicator display (e.g., an arrow, compass, etc.) and/or a signal quality profile display 131, in order to inform a user as to his proximity to areas of preferred signal quality. This distance information may be utilized by a user, for example, to decide whether or not it is feasible to move towards the preferred area(s), how long it will take the user to arrive at the desired location, what mode of transportation should be utilized to arrive at the preferred area(s) (e.g., walk, drive, etc.), and the like. Distance information may be compiled in the profiling device 120 from actual values or estimated values, and may be displayed with corresponding indicators to inform a user as to the source of the distance information. To illustrate, the distance information display 135 may be configured to display a color code which indicates that particular distance information includes actual distances, such as those determined via a GPS receiver. Similarly, a second color code may be utilized to indicate that the distance values are estimates, such as those derived via TDOA- or AOA-type calculations.

Although the features and elements of the present invention are described in the preferred embodiments in particular combinations, each feature or element can be used alone without the other features and elements of the preferred embodiments or in various combinations with or without other features and elements of the present invention. In addition, any of these features and/or elements may be implemented prior-to, during, or after the initiation of a communication link. To illustrate, prior to initiating a voice/data call, a user may implement the signal profiling, directional guidance, and display features of the present invention to determine whether he is in an area having a data rate that can support the transmission. If he is not, the user may elect to utilize the guidance indication feature to move towards the nearest desirable transmission area. To illustrate further, once the communication link has been established, the user (who is in motion) may utilize the guidance and distance features of the present invention to avoid entering areas of poor signal quality, thus avoiding an unexpected drop in the communication link.

What is claimed is:

1. A method for improving signal quality in a wireless transmit/receive unit (WTRU) operating in a wireless communication system, the method comprising:
determining a current location of a WTRU;
determining a current bearing of the WTRU;
obtaining signal quality measurements of a pre-determined geographic region, said region including the current location of the WTRU;
generating a signal quality profile of the geographic region based on the signal quality measurements; and
displaying, in the WTRU, the signal quality profile and a directional guidance indicator that indicates the current location of the WTRU relative to areas of preferred signal quality.

2. The method of claim 1, wherein a global positioning system (GPS) receiver is utilized to determine the current location of the WTRU.

3. The method of claim 1, wherein time difference of arrival (TDOA) analysis is utilized to determine the current location of the WTRU.

4. The method of claim 1, wherein angle of arrival (AOA) analysis is utilized to determine the current location of the WTRU.

5. The method of claim 1, wherein the current location of the WTRU is determined by a network device and reported to the WTRU.

6. The method of claim 1, wherein a GPS receiver is utilized to determine the current bearing of the WTRU.

7. The method of claim 1, wherein a smart antenna is utilized to determine the current bearing of the WTRU.

8. The method of claim 1, wherein a compass device is utilized to determine the current bearing of the WTRU.

9. The method of claim 1, wherein the current bearing of the WTRU is determined by a network device and reported to the WTRU.

10. The method of claim 1, wherein the signal quality measurements are measures of at least one quality parameter selected from the group consisting of received signal strength indicator (RSSI), bit error rate (BER), signal-to-noise ratio (SNR), frame error rate (FER), and data transmission rate.

11. The method of claim 1, further comprising displaying distance information for indicating a distance between the current location of the WTRU and areas of preferred signal quality.

12. The method of claim 1, wherein the signal quality profile is generated in an isobar format, wherein differing colors and lines are used to delineate areas in the pre-determined geographic region having varied signal quality.

13. The method of claim 1, wherein the signal quality profile incorporates a map of the pre-determined geographic region, wherein areas of differing signal quality are identified on the map.

14. The method of claim 13, further comprising periodically updating the signal quality profile as the signal quality profile changes.

15. The method of claim 14, wherein a network device generates the signal quality profile and reports said profile to the WTRU.

16. A WTRU for use in a wireless communication system comprising:
a location device configured to determine a current location of the WTRU;
a bearing device configured to determine a current bearing of the WTRU;
a metric collection unit configured to obtain signal quality measurements of a pre-determined geographic region, said region including the current location of the WTRU;
a profiling device configured to generate a guidance indicator based on the current location of the WTRU, and a signal quality profile of the geographic region based on the quality measurements; and
a displayer configured to display the signal quality profile and guidance indicator.

17. The WTRU of claim 16, wherein the location device is a GPS receiver.

18. The WTRU of claim 16, wherein the location device is further configured to utilize TDOA analysis for determining the current location of the WTRU.

19. The WTRU of claim 16, wherein the location device is further configured to utilize AOA analysis for determining the current location of the WTRU.

20. The WTRU of claim 16, wherein the location device is configured to receive and process location information from an external network device.

21. The WTRU of claim 16, wherein the bearing device is a GPS receiver.

22. The WTRU of claim 16, wherein the bearing device is a compass.

23. The WTRU of claim 16, wherein the bearing device is a smart antenna.

24. The WTRU of claim 16, wherein the bearing device is configured to receive and process bearing information from an external network device.

25. The WTRU of claim 16, wherein the metric collection unit is configured to interpolate a signal quality value for unmeasured location points within the geographic region, wherein said measured and interpolated quality values are used to generate a signal quality surface map of the geographic region.

26. The WTRU of claim 16, wherein the signal quality measurements are measures of at least one parameter selected from the group consisting of received signal strength indicator (RSSI), bit error rate (BER), signal-to-noise ratio (SNR), frame error rate (FER), and data transmission rate.

27. The WTRU of claim 16, wherein the profiling device is further configured to generate distance information for indicating a distance between the current location of the WTRU and areas of preferred signal quality.

28. The WTRU of claim 16, wherein the displayer is configured to display the signal quality profile in an isobar format, wherein differing colors and lines are used to delineate areas in the pre-determined geographic region having varied signal quality.

29. The WTRU of claim 16, wherein the displayer is configured to incorporate a map of the pre-determined geographic region into the signal quality profile display to create a signal quality profile map, wherein areas of differing signal quality are identified in the signal quality profile map.

30. The WTRU of claim 29, wherein the incorporated map is a local street map of the pre-determined geographic region.

31. The WTRU of claim 29, wherein the displayer periodically updates the signal quality profile map in response to periodical updates in the signal quality profile generated by the profiling device.

32. The WTRU of claim 29, wherein a network device generates the signal quality profile map and reports said profile map to the WTRU for display by the displayer.
